(19) United States
(12) Patent Application Publication
(10) Pub. No.: US 2025/0334984 A1
(43) Pub. Date: Oct. 30, 2025

(54) ADAPTIVE SLEW-RATE BOOSTER

(71) Applicant: NVIDIA Corp., Santa Clara, CA (US)

(72) Inventors: Xi Jiang, Palo Alto, CA (US); Vipul Katyal, San Jose, CA (US); Virendra Kumar, Mountain View, CA (US)

(73) Assignee: NVIDIA Corp., Santa Clara, CA (US)

(21) Appl. No.: 18/649,309

(22) Filed: Apr. 29, 2024

(51) Int. Cl. G05F 1/46; G05F 1/575; G05F 1/59

(52) U.S. Cl. CPC G05F 1/462; G05F 1/468; G05F 1/575; G05F 1/59

(57) ABSTRACT

Embodiments of voltage regulators that include a power transistor configured to provide a load current, a voltage follower configured to provide a gate voltage of the power transistor, and a circuit configured to transform the gate voltage of the power transistor into a mirror current of the load current and to adjust a current flow through the voltage follower based on the mirror current.

### BACKGROUND

Droop and overshoot that occur during large load transients may induce undesirable jitter into the load voltage. Traditional regulators may employ a sizable capacitor to mitigate this effect. However, integrating such a large capacitor onto a chip often proves impractical.

A number of conventional mechanisms exist to improve the response of regulators to changes in loading. However these conventional mechanisms tend to raise the power consumption of the regulator significantly or degrade the regulator's phase margin.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of a load voltage regulator circuit comprising an adaptive slew-rate booster.

FIG. 2 depicts slew rate boosting at the gate of a power transistor to reduce load voltage droop.

FIG. 3 depicts a load current sensor in one embodiment.

FIG. 4 depicts a comparator in one embodiment.

### DETAILED DESCRIPTION

Disclosed herein are embodiments of load voltage regulators utilizing adaptive slew-rate boosters. The regulators are configured to monitor the gate voltage of a power transistor configured to provide a variable load current. Herein, a ‘power transistor’ refers to a device that controls the current flow into a load.

The regulators may comprise a voltage follower configured to provide the gate voltage of the power transistor, and an adaptive slew-rate booster to transform the gate voltage of the power transistor into a mirror of the load current and to adjust a current flow through the error amplifier of the voltage follower based on the mirror current.

The current regulator may adjust the current flow through the voltage follower by applying an output of a comparator configured to generate the mirror current. To generate the mirror current, the comparator may utilize a scale replica of the power transistor with a gate driven by the gate voltage of the power transistor. A ‘scale replica’ is a device comprising similar response characteristics to an applied gate voltage, except the sizes (current capacities) of the original and replica may vary.

Multiple comparators may be utilized, each configured to trip at a different level of the load current. Herein, a comparator ‘trips’ when its output toggles based on a configured trip point. The trip point of the comparator may be determined by a size of the scale replica of the power transistor utilized therein. Each comparator may control a portion of the current available to flow through the voltage follower and thereby unbalance the current flows in the voltage follower (e.g., in the error amplifier) to an extent based on the replica currents (and hence the comparator trip points).

Other technical features may be readily apparent to one skilled in the art from the following figures, descriptions, and claims.

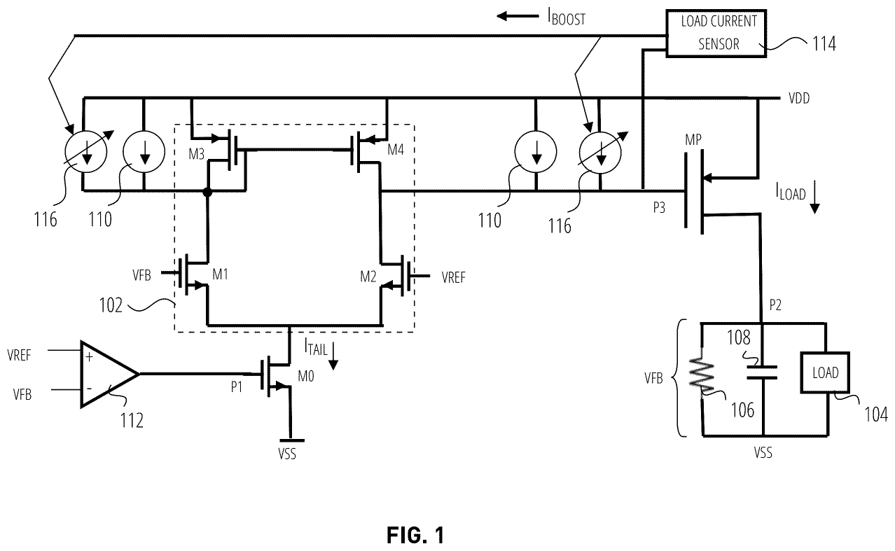

FIG. 1 depicts an embodiment of a load voltage regulator circuit comprising an adaptive slew-rate booster. A voltage follower 102 of reference load voltage VREF is implemented by transistors M1-M4 with feedback from the output voltage VFB across the load 104 (including resistive and capacitive elements 106, 108). A stable baseline amount of drive current is provided to the voltage follower 102 from the power supply rail VDD via fixed current sources 110, to provide a baseline amount of tail current Iₜₐᵢₗ for active regulation during low loading conditions. To enhance the open-loop DC gain, an amplifier 112 is coupled to the gate of the current source transistor (M0) to drive the tail current Iₜₐᵢₗ of the voltage follower 102.

The regulator comprises two feedback regulation loops each responsive to changes in the load voltage VFB: a slower-responding loop through amplifier 112, and a faster-responding loop through the voltage follower 102.

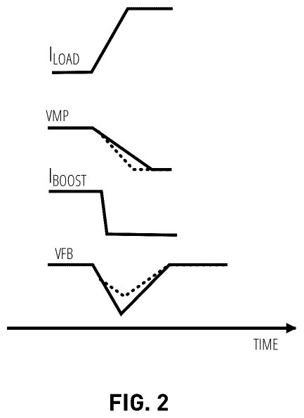

The load current sensor 114 monitors the load current I_{load} through power transistor MP and in response to changes therein generates a variable boost current I_{boost} through the adjustable current sources 116. The current flowing through transistors M3 and M4 is thus made proportional to the load current I_{load}, expressed as I_{M3/4}=I_{LOAD}/k, where k represents the size ratio of transistor MP to M3 and M4. Adapting the strength of the adjustable current sources 116 to supplement the fixed current sources 110 during rapid transients in load current demand may lead to reductions in load voltage ripple or droop effects, as depicted in FIG. 2.

In response to an upward change in the load current I_{load}, the gate voltage VMP of the power transistor (MP) will begin to decrease. (MP provides a high-current path to the load 104. MP may by implemented in some embodiments by a parallel configuration of thin-gate transistors each providing a portion of the overall current capacity). The rate of this decrease is constrained by the regulator's bandwidth or slew rate. Once the load current sensor 114 detects a sufficient change in VMP, it generates a change to the adjustable current sources 116, causing the combined current supplied by M3 and M4 and the fixed current sources 110 to mismatch the current demand of M1 and M2. The resulting current mismatch enables the error amplification within the voltage follower 102 to boost the slew rate at the gate of the MP to rapidly reduce droop on the load voltage. Similarly, if I_{load} exhibits a downward change, the load current sensor 114 will increase I_{boost} to the adjustable current sources 116, driving the error amplifier's output to higher voltage more rapidly to limit any overshoot of the load voltage.

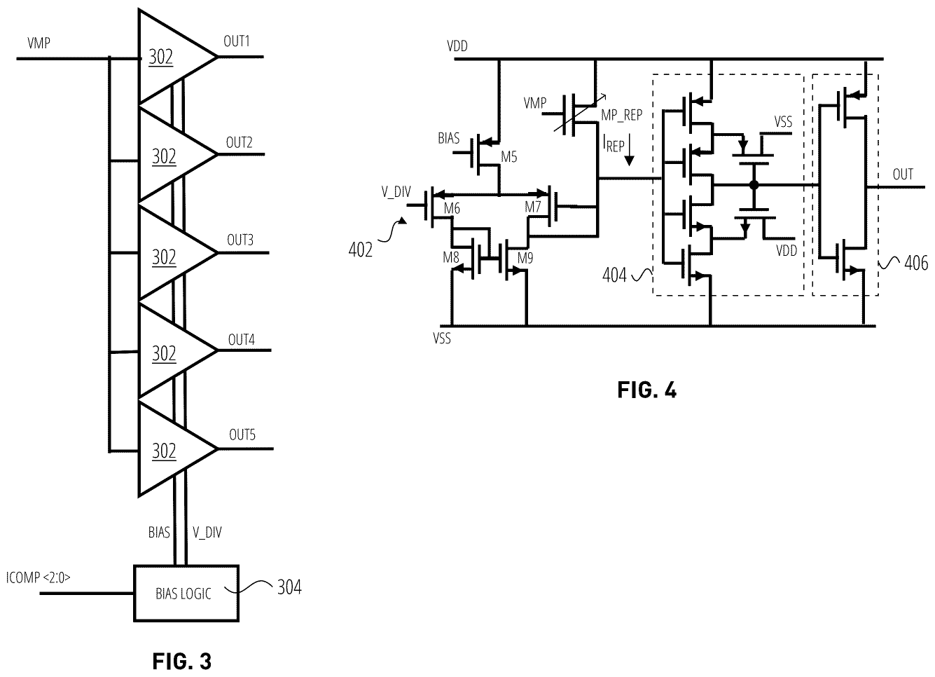

FIG. 3 depicts a load current sensor in one embodiment. Details of an embodiment of the comparator 302 are depicted in FIG. 4. The comparators 302 utilized in the sensor respond to the gate voltage VMP of power transistor MP in the regulator, but internally provide a comparison of the current passing through MP (I_{load}) and a bias current that configures a comparison threshold for each comparator 302. Therefor it should be understood that other circuit structures that provide this functionality (along with the voltage over-stress and ringing protections described below) may also be utilized for the comparators 302.

The load current sensor comprises a number of comparators 302 and biasing logic 304. Each comparator 302 comprises a transistor MP_REP of a similar device type as the load power transistor MP (e.g., similar or proportional threshold and mobility characteristics). A gate of MP_REP is coupled to receive the voltage VMP applied at the gate of transistor MP. The effective size of MP_REP may be made adjustable via calibration. Because MP_REP mirrors the responses of MP to gate drive, the current Irep is directly proportional to the current I_{load} in response to a given VMP applied to the gate of MP.

The drain node of MP_REP is connected to the output of a unit unity gain buffer/amplifier 402 formed by transistors M5-M9. Subsequent stages of the comparator include a Schmitt trigger 404 and an inverter 406. When VMP decreases due to an increase in load current, more current flows through MP_REP, charging its drain node at the input of the Schmitt trigger 404. In the absence of current from MP_REP, this node may be configured by the unity gain amplifier 402 to a potential of for example ¼ VDD. The unity gain amplifier 402 also acts as a low-impedance load on MP_REP, preventing substantial voltage fluctuations at the input to the Schmitt trigger 404 and protecting thin-gate devices utilized in MP_REP against voltage over-stress.

Utilizing the Schmitt trigger 404 configures the comparator with different rising and falling trip points for the input VMP, reducing the potential for ringing by the output OUT.

If the current supplied by MP_REP exceeds the bias current generated in the unit gain buffer by the applied BIAS voltage, the drain node of MP_REP charges up from ¼ VDD to VDD, driving the OUT signal of the comparator high and reducing I_{boost} to the adjustable current sources 116 in the regulator.

Each of the comparators 302 may be configured with a different threshold voltage (the level of I_{load} at which the comparator toggles OUT) in a number of ways. For example, the threshold voltage may be configured differently in each of the comparators 302 by configuring each with a different sized MP_REP transistor. Alternatively, the threshold may be configured differently in each of the comparators 302 by varying the current flow in the unity gain amplifier 402 (e . . . , by varying the BIAS voltage or V_DIV voltage for the comparators 302, or both, from the biasing logic 304. The other biasing voltage generating by the biasing logic 304, V_DIV, may be the same for all the comparators 302. Exemplary threshold settings for a five-comparator implementation are provided in Table 1.

TABLE 1
Comparator thresholds

| Comparator | OUT0 | OUT1 | OUT2 | OUT3 | OUT4 |
|---|---|---|---|---|---|
| I_{load} | 100 mA | 150 mA | 200 mA | 250 mA | 300 mA |
| Threshold | | | | | |

The size of the MP_REP transistor, and hence the trip point of a comparator, may be implemented with a number of parallel thin-gate device “fingers” (parallel current-carrying branches) in the device. For dynamically-tunable (field-tunable) operation, some subset of the total number of configured fingers may be enabled to or disabled from conducting current.

Although the depicted embodiment comprises five comparators 302, any number may be utilized, depending on the number of trip points called for by the particular application. Each comparator output (OUT1-OUT5) may be applied to control one “finger”, e.g., parallel branch, of the adjustable current sources 116. As I_{load} changes, more of the comparators 302 will trip, cutting off or turning on more or less current through the adjustable current sources 116.

### LISTING OF DRAWING ELEMENTS

102 voltage follower
104 load
106 resistive element
108 capacitive element
110 fixed current source
112 amplifier
114 load current sensor
116 adjustable current source
302 comparator
304 biasing logic
402 unity gain amplifier
404 Schmitt trigger
406 inverter

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A voltage regulator comprising:
a power transistor configured to provide a load current;
a voltage follower configured to provide a gate voltage of the power transistor; and
a circuit configured to transform the gate voltage of the power transistor into a mirror current of the load current and to adjust a current flow through the voltage follower based on the mirror current.

2. The voltage regulator of claim 1, the circuit further configured to adjust the current flow through the voltage follower with a comparator configured to generate the mirror current with a scale replica of the power transistor.

3. The voltage regulator of claim 2, wherein the comparator is configured with a trip point determined by a size of the scale replica of the power transistor.

4. The voltage regulator of claim 2, wherein a gate of the scale replica of the power transistor is configured to receive the gate voltage of the power transistor.

5. The voltage regulator of claim 1, the circuit further configured to adjust the current flow through the voltage follower with a plurality of comparators each configured to trip at a different magnitude of the load current.

6. The voltage regulator of claim 5, wherein each comparator is configured with a different sized scale replica of the power transistor.

7. The voltage regulator of claim 6, wherein each scale replica of the power transistor is configured to receive the gate voltage of the power transistor.

8. The voltage regulator of claim 5, wherein each comparator is coupled to control a portion of the current available to flow through the voltage follower.

9. A circuit comprising:
a voltage follower configured to compare a voltage on a load and a reference voltage; and
an adaptive slew-rate booster configured to transform an output voltage of the voltage follower into a replica of current drawn by the load and to adjust current flows within the voltage follower based on the replica of the current.

10. The circuit of claim 9, the adaptive slew-rate booster configured to imbalance current flows in an error amplifier of the voltage follower to boost a slew rate of the output voltage of the voltage follower.

11. The circuit of claim 9, the adaptive slew-rate booster further configured to adjust the current flow through the voltage follower with a comparator configured with a scale replica of a power transistor for the load.

12. The circuit of claim 11, wherein the comparator is configured with a trip point determined by a size of the scale replica of the power transistor.

13. The circuit of claim 11, wherein a gate of the scale replica of the power transistor is configured to receive the gate voltage of the power transistor.

14. The circuit of claim 9, the adaptive slew-rate booster further configured to adjust the current flow through the voltage follower with a plurality of comparators each configured to trip at a different level of the current drawn by the load.

15. The circuit of claim 14, wherein each comparator is configured with a different sized scale replica of the power transistor.

16. The circuit of claim 15, wherein each scale replica of the power transistor is configured to receive the output voltage of the voltage follower.

17. The circuit of claim 14, wherein each comparator is coupled to control a portion of a current flow to the voltage follower.

18. A voltage regulation process comprising:
generating a gate voltage to a power transistor of a load with a voltage follower; and
transforming the gate voltage into replicas of a load current in a plurality of comparators; and
unbalancing current flows in the voltage follower to an extent based on the replica currents.

19. The processor of claim 18, further comprising:
applying outputs of the comparators to increase or decrease the current flows in the voltage follower.

20. The process of claim 19, further comprising:
configuring each comparator with a different size scale replica of the power transistor.
